(19) United States
(12) Patent Application Publication
(10) Pub. No.: US 2017/0124878 A1
(43) Pub. Date: May 4, 2017

(54) COLLISION ADVOIDANCE DEVICES UTILIZING LOW POWER WIRELESS NETWORKS, METHODS AND SYSTEMS UTILIZING SAME

(71) Applicant: Quantum Dimension, Inc., Huntington Beach, CA (US)

(72) Inventors: Michael A Enright, Huntington Beach, CA (US); Harish Sridhara, Fountain Valley, CA (US)

(73) Assignee: Quantum Dimension, Inc., Huntington Beach, CA (US)

(21) Appl. No.: 15/343,195

(22) Filed: Nov. 3, 2016

Related U.S. Application Data
(60) Provisional application No. 62/250,498, filed on Nov. 3, 2015.

(51) Int. Cl. G08G 1/16

(52) U.S. Cl. CPC G08G 1/166

(57) ABSTRACT

A collision warning device including a receiver for receiving a low power radio frequency signal from a nearby radio frequency signal source. A processor can be electrically coupled to the receiver and configured to analyze the radio frequency signal for determining whether the signal is from a source capable of colliding with the device. The processor can be configured to provide a warning signal when it determines a potential of a collision. A method, a low power radio frequency signal source and a system are provided.

### CROSS REFERENCE TO RELATED APPLICATION

This application claims priority to U.S. Provisional Application Ser. No. 62/250,498 filed Nov. 3, 2015, the entire content of which is incorporated herein by this reference.

### BACKGROUND

Field of the Invention

The present invention relates to the devices for avoiding collisions with pedestrians, and more particularly to the electronic devices for avoiding collisions with pedestrians.

Description of Related Art

With the number of cyclists, motorcyclists and pedestrians increasing around the world, there is a greater potential for collisions between members of those groups with automobiles that can result in serious injury and death. Runners, and even cyclists for the matter, often move against the flow of traffic to attempt to avoid collisions, which can be dangerous at intersections where vehicles are not anticipating individuals moving against the traffic flow. Motorcyclists, in general, are usually at higher speeds than regular traffic flow on roads and can be involved in risky maneuvers such as cutting across lanes of traffic, which can provide little reaction time to other vehicles.

Different solutions have been proposed and implemented to inhibit such collisions. For cyclists, current solutions include carrying devices such as mirrors, cameras and even radar to alert the cyclist when vehicles are present. These solutions don't generally apply to pedestrians, where the main defense against collisions is often being constantly aware of potential colliders. There are issues with devices that are meant to detect the presence of vehicles. One requirement in using such devices for cyclists is that they require the cyclist to continually monitor the mirror, video camera or radar. While it may be advantageous to know that a car is in the vicinity, for example cars are almost always present in urban areas, information related to the presence of automobiles can be useless. This can also be the case in rural areas, where a cyclist or pedestrian may hear a vehicle long before it presents a danger.

A better and more robust safety solution is one where vehicles are made aware of cyclists, motorcyclists and pedestrians before a potential collision. For example, more advanced cars have cameras to monitor for pedestrians. One example is vehicle backup cameras. Some vehicles have forward-facing cameras, designed to detect objects in front of the vehicle. However, camera-based monitoring systems require pedestrians or cyclists to be in the field-of-view to be detected successfully. Additionally, such systems can be difficult to use when driving the vehicle since attention must be taken away from the road. Automated systems can be used to free the driver from having to continually monitor the display, but these systems are still limited by weather effects such as rain or fog, detection accuracy and other factors. Many automobiles do not yet have monitoring capability built into the vehicle, so there is no protection for cyclists and other pedestrians with respect to these vehicles.

In light of the foregoing, a new approach is needed that can operate independently of the aforementioned solutions, for example in the event that the vehicle does not have the foregoing technologies, or in combination with them to provide added safety.

### BRIEF DESCRIPTION OF THE DRAWINGS

FIG. 1 is a schematic illustration of one embodiment of a sensing device of the invention.

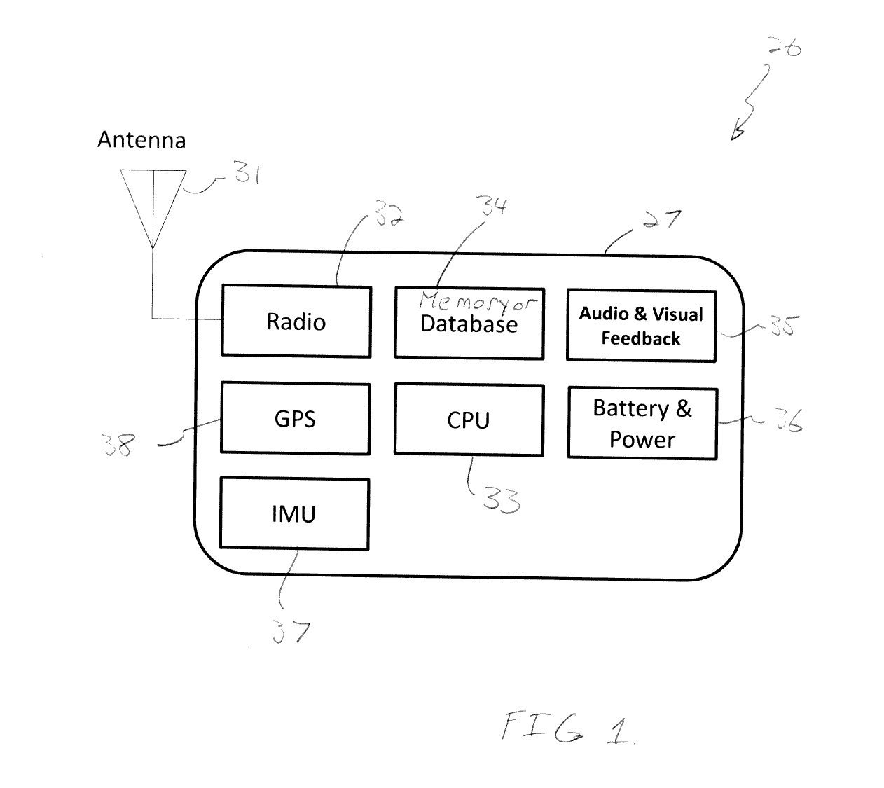

FIG. 2 is a schematic illustration of one embodiment of a pulsing device of the invention.

FIG. 3 is a block diagram of one method of the invention.

FIG. 4 is a block diagram of one method of the invention.

FIG. 5 is a schematic illustration of one embodiment of a system of the invention.

FIG. 6 is a schematic illustration of one application of the invention.

FIG. 7 is a schematic illustration of another application of the invention.

FIG. 8 is a schematic illustration of a further application of the invention.

FIG. 9 is a schematic illustration of yet another application of the invention.

### DETAILED DESCRIPTION

In one embodiment of the invention, a device for avoiding collisions using signals from low power wireless devices or networks is provided. For the purposes of the application, “power” or “low power” relative to a signal refers to the power level of the transmitted signal not the received signal power, which due to path loss is always lower than the transmit power. Networks of this type are referred by different names. In one embodiment, such networks include personal area networks (PANs), body area networks (BANs) and near-me networks (NANs). Devices in such networks typically use lower power transmit signals to minimize the effective distance, or range, by which the signal can be received and increase spatial diversity. In one embodiment, these signals have a target reception area on the order of a few meters to a few tens of meters. In comparison, a wireless local area network (WLAN) such as WiFi has a range of 200 meters, and cellular and digital television signals have a range of tens of kilometers.

One strength of this innovation is that low power wireless network transmitting signals are ubiquitous. For example, low power wireless transmitters are present in bike sensors, watches, smartphones, mobile devices, heart rate monitors, bicycle cadence meters, bicycle power meters, bicycle speed sensors, wearable devices and other personal devices. In addition, low power wireless transmitters are being integrated into products that include jackets, vests, jerseys, shirts, socks and other clothing, bicycle and other helmets and baby strollers. Such transmitters are carried by or worn by pedestrians, bicyclists, motorcyclists or sports participants, among others. The marketspace of products having low power wireless signal sources, with reduced interference to other receivers, is included within the context of the Internet of Things (IoT). The short transmission range of low power wireless network signals can advantageously indicate that the source or user is within collision range. A wireless signal source that transmits a high-power signal could be of lesser value because the signal detection range could be far outside of the collision range. Such suitable signal sources can be referred to as lower power signal sources or generators since their coverage area, or range, is limited. In one embodiment, any of the foregoing low power wireless transmitters can be suitable signal sources for interacting with the devices of the invention.

In one embodiment, devices of the invention can include any low power wireless network device of the type governed by 47 CFR §15.247. In one embodiment, devices of the invention can include any low power wireless network device transmitting or receiving radio frequency signals in the frequency bands of 902 to 928 MHz, 2400 to 2483.5 MHz, 5725 to 5850 MHz or any combination thereof. In one embodiment, devices transmitting low power signals in such bands have a maximum power not greater than the maximum power permitted under 47 CFR §15.247 for the respective band or signal type in the band. In one embodiment, devices transmitting low power signals in such bands have a maximum power not greater than the maximum power permitted under 47 CFR §15.249 for the respective band or signal type in the band. In one embodiment, devices of the invention can include any low power wireless network device transmitting or receiving radio frequency signals in the frequency bands of 902 to 928 MHz and having a maximum power of 30 dBm, 2400 to 2483.5 MHz and having a maximum power of 20.97 dBm or 30 dBm, 5725 to 5850 MHz having a maximum power of 30 dBm, or any combination thereof. In one embodiment, devices of the invention can include any low power wireless network device transmitting or receiving radio frequency signals is in the frequency bands of 2400 to 2483.5 MHz and having a maximum power of 10 dBm, which can currently include Bluetooth Low Energy (BLE). In one embodiment, devices of the invention can include any low power wireless network device transmitting or receiving radio frequency signals using ANT, ANT+, Bluetooth, BLE or any combination of the foregoing. In one embodiment, devices of the invention can include any low power wireless network device of the type governed by 47 CFR §15.249. In one embodiment, devices of the invention can include any low power wireless network device transmitting or receiving radio frequency signals in the frequency bands of 902 to 928 MHz and having a maximum power of −1.25 dBm, 2400 to 2483.5 MHz and having a maximum power of −1.25 dBm, 5725 to 5850 MHz having a maximum power of −1.25 dBm, or any combination thereof. In some instances where multiple maximum powers are set forth above, the maximum power is dependent upon the type of signal. In one embodiment, devices of the invention can include any combination of the low power wireless network devices disclosed herein. Sensing or receiving devices of the invention can receive low power wireless signals from one or more signal sources.

In one embodiment, the devices, method and system of the invention can avoid collisions by sensing signals generated from one or more signal sources with no requirement to connect to, nor activate, the signal generating devices. The signals that are being sensed can be broadcast from one or more devices or sources typically used by cyclists and pedestrians. In one embodiment, a core capability of the system of the invention is the capability to detect signals from one or more of these signal sources in a connectionless manner and subsequently alert the user of the system. In one embodiment, connectionless means no two-way transmissions between the system user and the signal source. Rather, all transmission is one way, that is from signal source to user. In one embodiment, an alert can notify the user that the source of the signal is within range such that a collision or other event of interest may occur. By determining that a source of the signal is within range, the user may take action to avoid an event, such as a collision, or to ensure that they are not on a collision path.

Although discussed herein in the context of a collision, it is appreciated that the system, devices and methods of the invention can be utilized for detecting or avoiding other events. In the context of collisions, the system, devices and methods of the invention can be utilized for detecting possible collisions between pedestrians and vehicles, pedestrians and bicycles, bicycles and vehicles, sports participants and vehicles, industrial equipment such as forklifts and containers, drones that are operating within near proximity to each other, and pedestrians or sports participants and any object. The vehicles can be of any type, for example automobiles, buses, trucks or street cars. For simplicity, the discussion herein will involve possible collisions between pedestrians or cyclists and vehicles of any type.

One advantage of invention is that low power wireless network signal sources not in the field-of-view of the user or any camera vision or radar systems can be detected and alert the user to a potential collision. In one embodiment, the present invention is directed to warning a user of proximity to other devices that have the potential for collision. The invention can improve the notification time to users in order to avoid a collision completely or in the least take measures to reduce the impact of collision.

The system and methods of the invention can be particularly advantageous in the ability to enable the avoidance of vehicular and pedestrian collisions. With the advent of low power wireless standards such as ANT, ANT+, Bluetooth, and BLE that are currently employed as part of many personal communication devices, there are many sensors that can be detected for collision avoidance.

The foregoing embodiments of the invention can be combined in any manner. The embodiments of the invention set forth below are examples of the invention, and may in some instances be broader than the foregoing embodiments of the invention but are not intended to limit the breadth of the foregoing embodiments or the breadth of the invention. Additional features of the invention set forth in the embodiments of the invention set forth below are optional. A feature of any embodiment set forth below can be combined with any of the foregoing embodiments, with or without any other feature of any embodiment set forth below. All characteristics, steps, parameters and features of the methods below are not limited to the specific embodiments or specific parts set forth below, but instead are equally applicable to the foregoing embodiments of the invention and to all embodiments of the invention. Broad terms and descriptors are sometimes replaced herein with more specific terms and descriptors, not to limit a disclosure to a specific term or descriptor but merely for ease of discussion and understanding.

A receiving or sensing device of the invention can be of any suitable device. In one embodiment, the receiving or sensing device of the invention can be of any suitable size, and can for example be of a size and shape to be handheld, to be carried or worn on the clothing of the use, to be mounted on a bicycle, to be mounted on the handlebars of a bicycle, to be mounted on visor of a vehicle, to be mounted on a windshield or dashboard of a vehicle, or to be attached to a forklift or other piece of industrial equipment, a backpack or other item carried by a user or a baby stroller or other consumer item. The receiving or sensing device of the invention can be pocket sized. Such device can detect pedestrians and cyclists, for example by means of detecting certain lower power signals generated by devices carried by such people. In one embodiment, receiving or sensing device 26 can optionally include a body or housing 27 having therein an antenna 31, a multichannel or other radio unit 32 that that is capable of transmitting and receiving a plurality of radio frequency (RF) signals, and a central processing unit (CPU) or processor 33 coupled to the radio unit that can perform calculations or comparisons, including to determine whether received signal is of a type expected to be generated by a device carried by nearby a pedestrian or cyclist. The housing can additionally include a database or other memory 34 coupled to the processor 33 that for example can store identifiers of the types of codes and signals that would be representative of pedestrians or cyclists being present or nearby. In one embodiment, processor 33 can be configured to analyze the received signal to determine whether the signal is from a source capable of colliding with the user of device 26. In one embodiment, the processor 33 initially compares the received signals against predetermined types of radio frequency signals to arrive at a selected or subset group of received signals. Such selected signals are then analyzed to determine whether the signal is from a source capable of colliding with the device 26. In one embodiment, processor 33 can be configured to determine the potential of a collision based upon the reception strength of the signal. In one embodiment, additional information, which can include relative location data, can be utilized to determine the potential of a collision. An alarm system 35 capable of alerting the user of device 26 to pedestrian traffic or otherwise of the nearby presence of a person can be provided, and coupled to the processor 33, to provide audio feedback, visual feedback or both. Power to device 26, including radio 32, processor 33, memory 34 and feedback device or alarm 35, can be supplied through rechargeable or other battery 36. The device 26 can include an inertial measurement unit (IMU) 37 for detecting or measuring motion and any suitable positioning technology such as a GPS receiver 38, each additionally coupled to battery 36 and processor 33, that for example allow the device 26 to integrate location of a nearby detected pedestrians, cyclists or other person with position information of the user of device 26. Processor 33 can be programmed to perform its functions utilizing software, firmware or both.

In one embodiment, the sensing or receiving device of the invention is mounted in a vehicle, for example to scan for low power wireless signals being transmitted by a low power wireless network device carried by a pedestrian, a cyclist or a motorcyclist. In one embodiment, the sensing or receiving device, for example device 26, is removably mounted in the vehicle, so as to be portable and useable away from the vehicle. In one embodiment, the sensing or receiving device is incorporated into the vehicle, for example purchased with the vehicle or not ordinarily usable away from the vehicle.

In one method of the invention, a user estimates the presence of people or objects by listening for wireless signals in the area. The sensing or receiving device of the invention can be utilized in this regard. In one embodiment, “listening” can refer to the process of receiving low power wireless signals from suitable low power wireless transmitters in the area and determining whether these signals correspond to objects that may be in the path of the user and have the potential to cause a collision. Such transmitters, for example, can be any of the low power wireless transmitting device described herein. Because many types of wireless signals may be present at any time, in one embodiment the sensing or receiving device of the user, such as device 26, first determines which types of signals are of importance and which of that type of signal will cause an alert notification to the user. If, for example, the sensing or receiving device determines that the type of signals is included within a predetermined type of radio frequency signal, the sensing or receiving device can then analyze the signals, for example by processor 33, to determine whether the signal is from a source capable of colliding with the sensing or receiving device, including the user of such sensing or receiving device.

In one method of the invention, device 26 can investigate the various fields of the messages or signals that are being sent or transmitted in its vicinity, whether these are broadcast (one-way communication) or traffic (two-way) channels. In one embodiment, processor 33 of device 26 can compare this signal or information to a predetermined set or list of signals stored in an internal database or other storage 34. If the received signal matches one of the stored signals in memory or storage 34, processor 33 can inform the device that the received signal originates from a source that has the potential cause a collision. An example of a wireless signal that can originate from a candidate source is the signal from any suitable low power signal generator or source that uses ubiquitous wireless signals such as ANT, ANT+ and BLE. In a scenario where the device 26 is scanning for pedestrians, for example where device 26 is mounted in a car, a cellular tower mounted on top of a building would not represent a potential candidate for collision since it is not transmitting the requisite waveforms or codes and the type of signal generated by a cellular tower would not be stored in memory 34 of the device 26.

In one embodiment, a pulse or transmitting device can be provided. In one embodiment, the pulse or transmitting device of the invention can be of any suitable size, and can for example be of a size and shape to be handheld, to be carried or worn on the clothing of the use, to be mounted on a bicycle, to be mounted on the handlebars of a bicycle, to be mounted on visor of a vehicle, or to be mounted on a windshield or dashboard of a vehicle, a backpack, a babystroller, on a box of equipment permitting detection of proximity to the box of equipment, or on a door or window to sense motion, for example with an IMU on the device. The pulse or transmitting device of the invention can be pocket sized. In one embodiment, the pulse or transmitting device is a wireless transmitter of low power signals, for example one or more of any of the low power wireless signals disclosed herein. It one embodiment, the pulse or sensing device uses wireless signals such as ANT, ANT+ and BLE. In one embodiment, the pulse or sensing device is a dedicated wireless transmitter, and in one embodiment delivers safety payload information via multiple RF channels using any suitable low power wireless signals such as ANT, ANT+ and BLE. In one embodiment, the safety payload includes information gathered by the transmitting device from the user. Examples can include GPS coordinates, speed, position estimates from the IMU, future GPS coordinates that describe the user's destination path and other parameters related to the user's direction and destination. In one embodiment, a broadcast of a need for help can be included within the safety payload. For certain applications, for example warehouse applications, other information can be broadcast in the payload such as storage date for a container on which the pulse device is mounted. Other suitable messages or other information can be included in the payload, for example dependent upon the application in which the pulse or transmitting device is utilized.

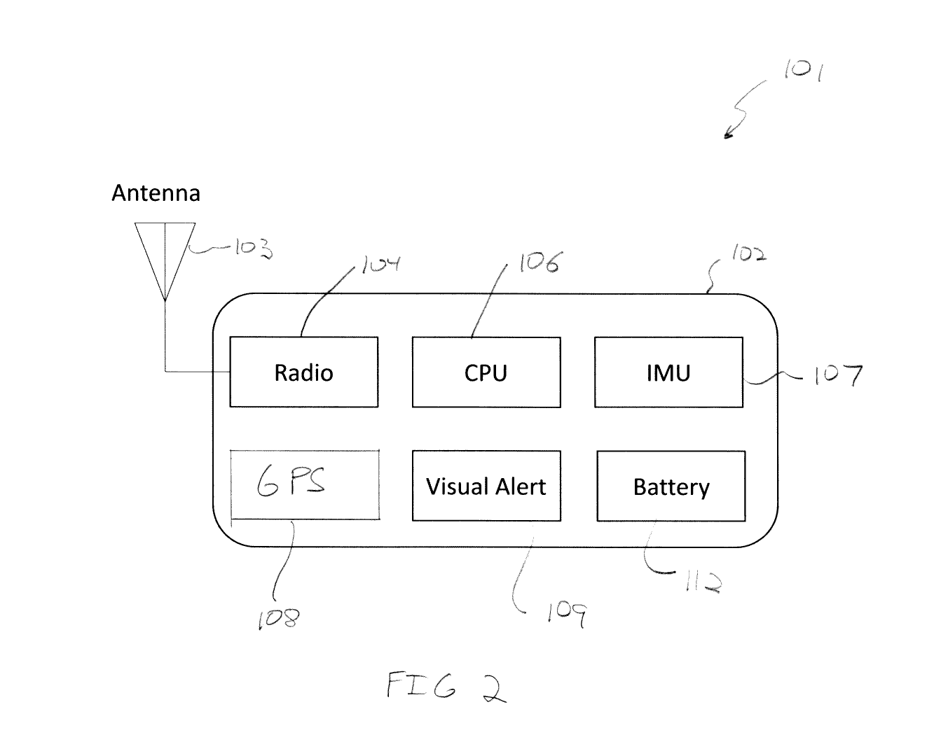

In one embodiment, the pulse or transmitting device 101 is provided and can optionally include a body or housing 102 carrying an antenna 103, a multichannel or other radio 104 for example that is capable of transmission and reception of radio frequency signals, and a central processing unit or processor 106 coupled to the radio that can generate the safety payload data and determine whether to broadcast or not based on certain conditions (see FIG. 2). A suitable IMU 107 can be included in the housing 102 to detect motion, and a suitable GPS device 108 can be provided, each coupled to processor 106. A visual feedback mechanism, such as an LED 109, can be included in the housing. A suitable power supply 112 is included in device, for example a rechargeable or other battery, that can be coupled to the radio 104, processor 106, IMU 107, GPS device 108 and alert mechanism 109. Processor 106 can be programmed to perform its functions utilizing software, firmware or both. Device 101 can be configured to broadcast over any suitable low power frequency, for example one or more of any of the low power frequencies disclosed herein.

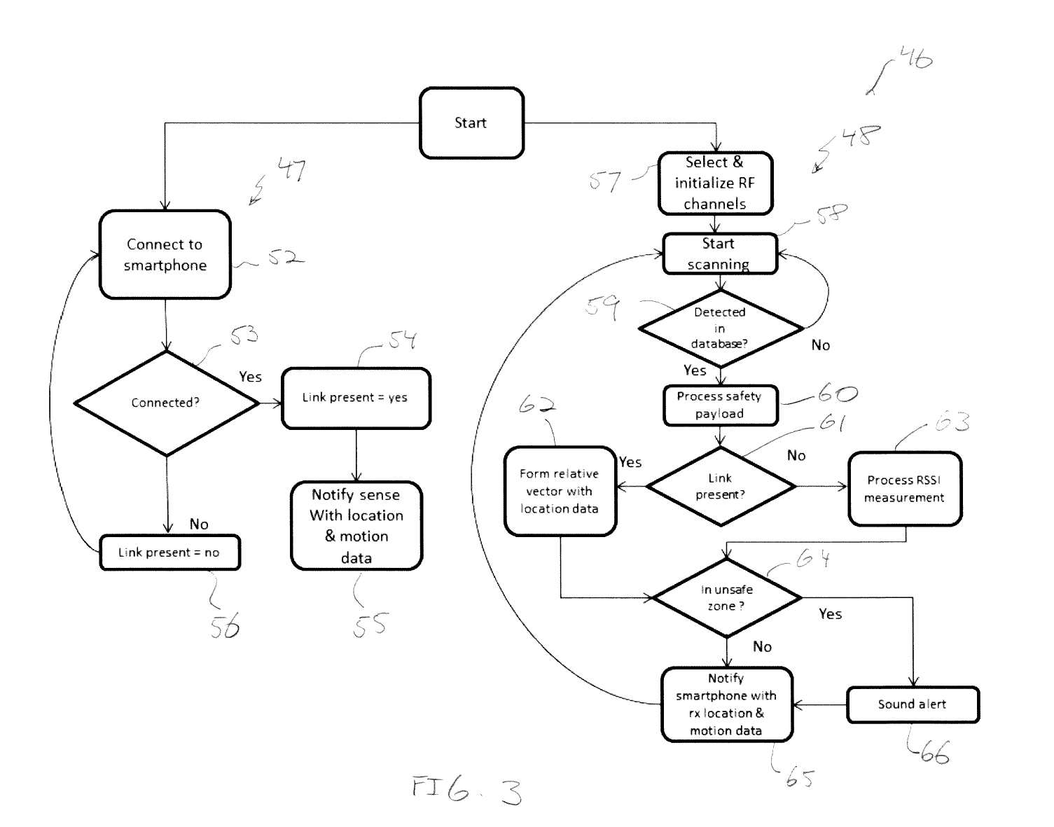

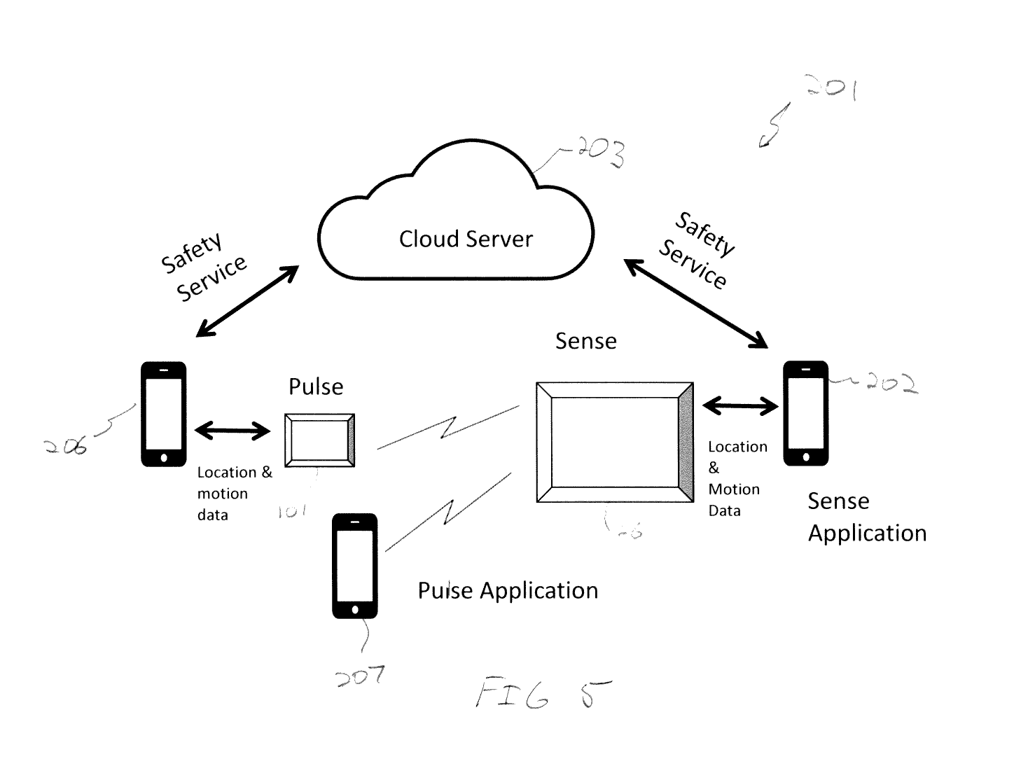

One embodiment of method for operating a sensing and receiving device of the invention, with or without a pulse or transmitting device of the invention, is illustrated by flowchart 46 in FIG. 3. In this embodiment, there are two processes 47 and 48 running concurrently, for example on CPU 33 of device 26. Process 47 is optionally provided to connect the sensing or receiving device, such as device, to a nearby smartphone or other mobile device. The device 26 and a suitable smartphone or other mobile device, for example smartphone 202 in FIG. 5, must be in sufficient close proximity to each other so as to permit the pairing of the smartphone and the device 26. The smartphone can have a suitable application, such as a downloadable application, for coordinating with device 26. Due to such close proximity, in one embodiment the device 26 and the smartphone 202 can share the same location information as determined by any suitable position and location technology, including but not limited to GPS functionality present in the smartphone 202. This location information can also be available via a GPS 38 or other position location technology provided in device 26. In one method 47 of sharing location information, motion information or both, in step 52 the device 26 continually tries to connect to an application on smartphone 202 through any suitable pairing process. In step 53, for example in device 26, it is ascertained whether such connectivity has happened successfully. If connectivity has been achieved, for example as determined in step 54, then in step 55 the smartphone 202 or other mobile device can transmit its location and motion data to device 26, for example through an application on smartphone 202. Utilization of the smartphone for providing location data, motion data or both can enhance the battery life of device 26. If a link between the smartphone and the device 26 cannot be established, for example in step 56, process 47 returns to step 52 to further attempt to connect device 26 to the smartphone.

In process 57, for example simultaneously running on device 26, CPU 33 of the device can utilize radio 32 and communicate to it the radio frequency channels, for example certain predetermined types of radio frequency signals, to scan for in step 58. When the radio 32, for example upon its completion of such scan, returns results of scanning in the form of identified transmitting devices utilizing such radio frequency channels, in step 59 the processor 33 can analyze or compare the signals of such devices, for example by searching a database or memory such as memory 34 of device 26, to determine whether the signals correspond to low power wireless signals from transmitting device based on the database entries, or a pulse device 101. If step 59 determines that suitable transmitting devices are found, in step 60 the device 26 obtains payload information from the detected transmitting devices, which can contain the address of the transmitting device and the transmit signal strength of the transmitting device. The payload information can additionally obtain, if for example the transmitting device is a pulse or transmitting device of the invention such as device 101, motion information and location information of the transmitting device. The payload information can additionally include other safety information relative to the safety features of the invention. In step 61, the device 26 determines if a connection or link to smartphone 202 is present. If such a connection is not present, the device uses received signal strength measurements of the low-power signal source or transmitter from radio 32 of the device 26 to make a judgement in step 63 about whether the transmitting device is in close proximity to the device 26. If the link to smartphone 202 is present and the transmitting device is device 101 or another transmitting device that can provide its location data to device 26, the device 26 can additionally utilize the requested location and motion data from the smartphone, which typically corresponds to the location and motion data of device 26 since both device may be carried by a user, and form relative position vectors in step 62 between the GPS location of device 26 and the GPS location of device 101 provided in the payload information received from the transmitting device 101. The foregoing information can be analyzed in step 64 to determine whether the device 101 or other transmitting device and the receiving device 26 are in close proximity to each other. If there is a potential for collision, the device 26 can immediately issues an audible and/or visual alert in step 66, for example through feedback device 35 in device 26, to lookout for potential collisions between the user of device 26 and the person utilizing the device 101 or other low power signal source or transmitter. If a connection between device 26 and the smartphone 202 can been made and maintained, the device 26 can notify the smartphone 202 in step 65 with the foregoing received safety and payload information, which for example can be communicated back to a cloud server 203 through a safety service as for example illustrated in FIG. 5. If no transmitting devices are found, device continues to search or scan in step 58 for such devices. When more than one device is found in step 58, additional functionality is possible where relative positions vectors can be utilized to create a safety net. Connection of smartphone 202 to cloud server 203 is possible by any suitable means, for example cellular or Wi-Fi connections from the user's device or smartphone. The cloud server can houses the information supplied by the pulse or sense device. In one embodiment, the sense information collected can be used to provide real-time mapping capability of pedestrian locations to allow a driver to avoid areas of congestion. The pulse device can also have this ability for cloud service. Different information may be disseminated or sent to the cloud server dependent upon the application. For example, for warehouse applications the information sent to the cloud server can include locations, for example instantaneous location, periodic locations or locations over time, time of storage, last container access and other desirable information.

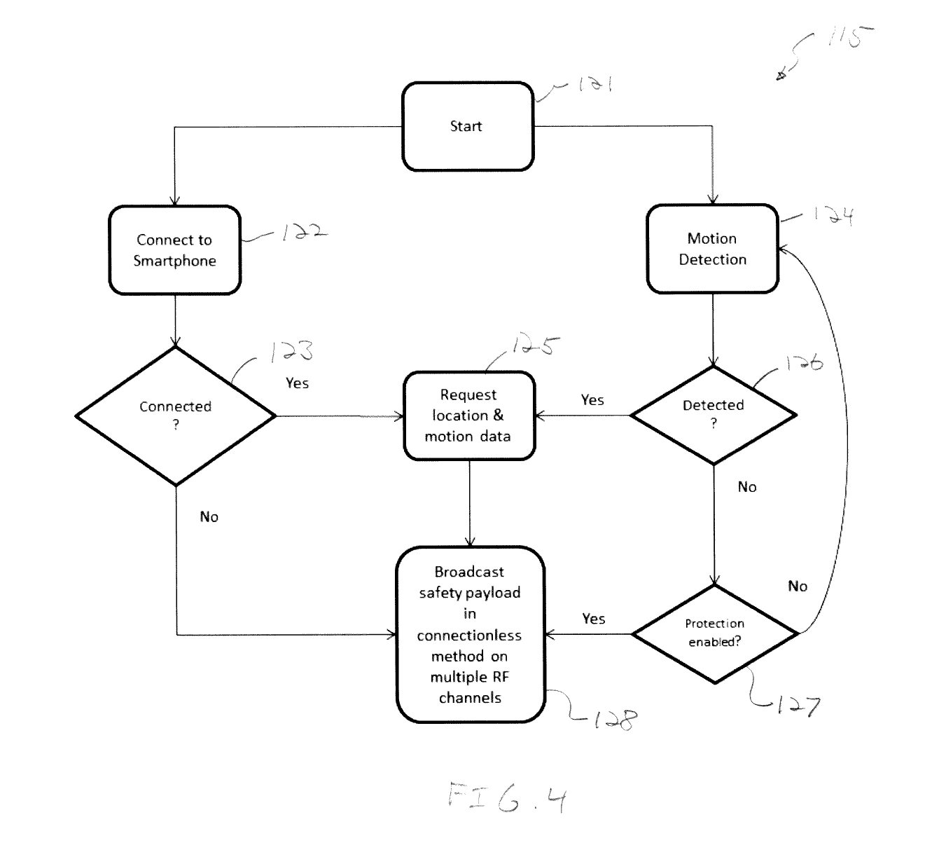

In one method 115 of using the pulse or transmitting device of the invention, illustrated in FIG. 4, the pulse or transmitting device has two dedicated processes 122 and 124 running, for example by processor 106. Process 122 is provided to pair with a smartphone or other mobile device and process 124 is provided to continually utilize IMU 107 in device 101 to detect motion of a pedestrian, bicycle, motorcycle or other object on which the device 101 is mounted. Motion detected in step 124, for example by IMU 107 in device 101, can include for example bicycle motion, motorcycle motion, pedestrian motion, a falling object or person in a three-dimensional space, other types of motion or any combination of the foregoing. Device 101 and a smartphone or other mobile device, for example smartphone 206 in FIG. 5, must be in sufficient close proximity to each other for such two devices to wirelessly pair in step 122. Once so paired, device 101 and smartphone 206 can share the respective location information, which can be determined by a variety of position and location technologies, including but not limited GPS present in the smartphone 206 or GPS optionally provided in device 101. This location information could also be available via a GPS or other position device 107 optionally present in pulse device 101. Utilization of the GPS technology in the smartphone 206 can enhance the battery life of device 101. The smartphone or other mobile device 206 can have an application or process running called pulse application 207, for example a downloadable application, which for example allows pairing of the smartphone 206 with device 101 to happen successfully as determined by methodologies present in, including but not limited to BLE. The pulse application on phone 206 can additionally monitor the location data obtained by the phone. IMU 107 in device 101 can provide motion data and optional GPS receiver 108 can provide location data to device 101, for example via antenna 103, as requested by the device after connection establishment. Step 122 in device 101 continually tries to connect to pulse application 207 on smartphone 206 through the pairing process. In step 123, device 101 ascertains whether connectivity with smartphone 206 has occurred. If a connection has been achieved, in step 125 location data from pulse application 207 on smartphone 206 is requested by device 101. The motion detected in step 124 can trigger a process in step 128 to broadcast the GPS coordinates or other data, such as data from the IMU 107 in device 101, in the form of a broadcast message over one or more low power radio frequency channels. Transmit signal strength information can be available, for example, from the radio 104 in device 101. The broadcast message can contain safety payload information, which can include an orderly arrangement of identifiers such as the address of the device 101 and other suitable information relative to the safety features of the invention. In one embodiment, the safety payload can include location and motion data received by device 101 from application 207, location data from GPS 108 of the device 101, motion data from IMU 107 of the device 101, transmit signal strength data of radio 104 of the device 101, identifiers for the class of vehicle such as motorcycle or bicycle or pedestrian utilizing the device 101 or any combination of the foregoing. When no motion is detected by IMU 107, protection is enabled in step 127 and for example device 101 enters a sleep or other low power mode to conserve battery life. The device 101 can be reenabled again, in step 124, when further motion is detected by IMU 107.

When not connected to a smartphone or other mobile device, pulse device 101 can continually broadcast location data from IMU 107 in the safety payload information. Such location data can include, for example, motion of the object on which device 101 is carried or mounted. In one embodiment, pulse device 101 does not require smartphone 206 to be present for it to function and can work autonomously in all situations. In one embodiment, the pulse application 207 can function autonomously on smartphone 206 without connection to device 101 to transmit its safety payload information via broadcast message on different low power radio frequency channels, for example as shown in FIG. 5, and thus serve as a low power wireless signal source suitable for use with the sensing and receiving device of the invention.

One embodiment of a system of invention that includes devices 26 and 101 is illustrated in FIG. 5. In system 201, portions of which have been discussed above with respect to FIGS. 3-4, device 26 can be connected to a smartphone or other mobile device 202 through any suitable wireless technology, such as ANT, BLE or ANT+. In one embodiment, the smartphone is in close proximity to or inside a vehicle, such as a car or truck, in which for example device 26 is carried. Smartphone 202 can be connected to a cellular network or any data technology, such as in-car WiFi, to have access to the Internet. The smartphone 202 can communicate to a cloud server 203 that can provide a variety of services, such as safety services. In one embodiment, he safety services can include the dissemination of location, speed, direction, final destination, need for help and other messages supplied by the device 26. In one embodiment at the cloud, information from different users can be aggregated to provide real-time mapping capabilities of users current and future locations. This can be of benefit to drivers to avoid areas of high congestion. The need for help service could alert local authorities or other users who subscribe to the cloud service of a request for a need for help. Device 26 can have two-way access to the service and can provide the server with location data that it obtains from IMU 37 and motion data that it obtains from GPS receiver 38 of the device 26. Device 101 can be connected to another smartphone or mobile device 206 in sufficient close proximity to the device 101, for example using the pulse application 207 or other applications on the smartphone. For example, the smartphone or other mobile device may incorporated into or located in an automobile or other vehicle in which the user of device 101 is traveling or on a pedestrian carrying the device 101. Similar to device 26, device 101 can have access to the services of cloud server 203, for example through its connection with smartphone 206, and be connected to the Internet through various data access mechanisms provided in the smartphone. In one embodiment, device 26 and device 101 may not be in proximity to each other but can come into closer range over time, for example as one or both of such devices is being carried by a user traveling on a road. Safety payload broadcasts from device 101 can be picked up by device 26 and can be processed by processor 33 of the device 26, for example in any manner discussed herein including in FIG. 3, and can alert the user of the device 26 of an impending collision, for example with the user of device 101 or another suitable low power wireless signal source. In one embodiment, device 26 can provide visual and/or audio alerts, for example through feedback mechanism 35, of the presence of a nearby object that may collide with the user of device 26 or send a notification to a nearby smartphone or others, for example as disclosed herein. Cloud server services can provide individualized services to build better and safer routes for motorcycles, bicycles or other users of the system. In one embodiment, the cloud server services incorporate data learning mechanisms, for example for prediction of future traffic patterns based upon measured user patterns. In one embodiment, the cloud server services can be utilized for location services in conjunction with various mapping services available online or over the Internet.

In one embodiment of the invention, a smartphone or other suitable mobile device than can be configured or programmed in any suitable manner, for example by means of a downloadable application, to receive one or more low power wireless signals of the type disclosed herein from any suitable low power wireless signal generator of the type disclosed herein, analyze the signals for example by any of the procedures disclosed herein, determine whether a potential for collision between signal generator and the smartphone may or could exist and optionally alert the user of the smartphone, the user of signal generator or both of such potential for collision in any suitable manner. The process for determining whether a potential for collision may or could exist can include any of the methods or processes disclosed herein, including analyzing the signal type, the signal strength, any feature of the signal or any combination of the foregoing with respect to the signal received from the signal generator. In one embodiment, the signal generator is capable of providing location data of the signal generator to the smartphone, and the smartphone can utilize such received location data in its analysis as to whether the potential for collision may or could exist. In one embodiment, the signal generator is a smartphone or other suitable mobile device.

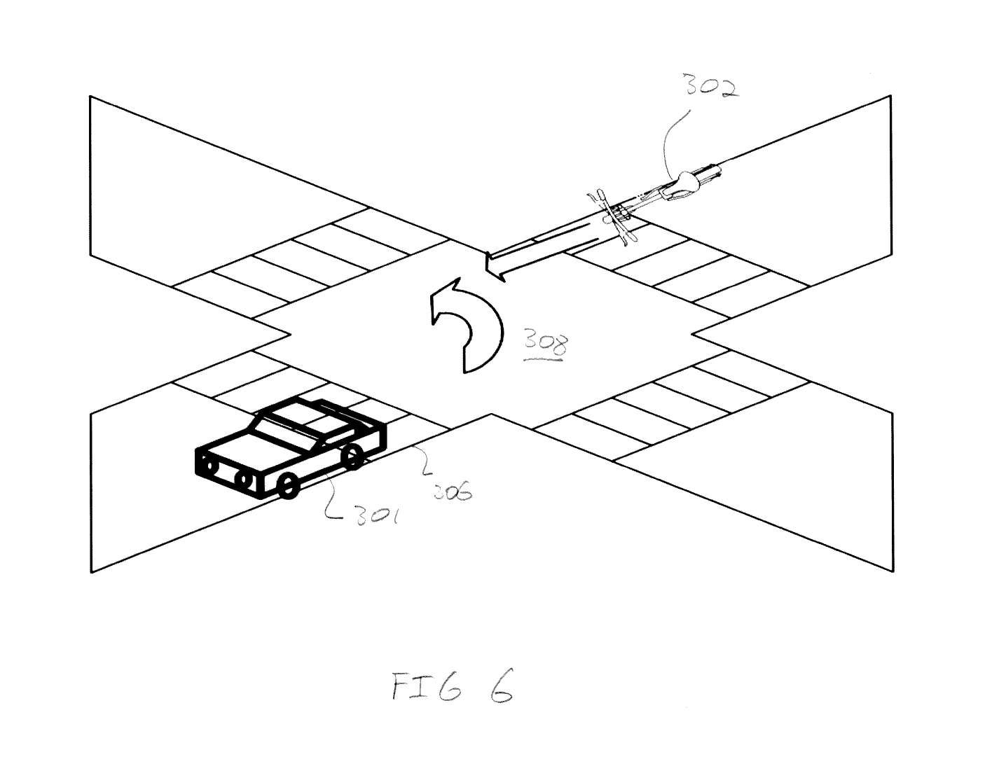

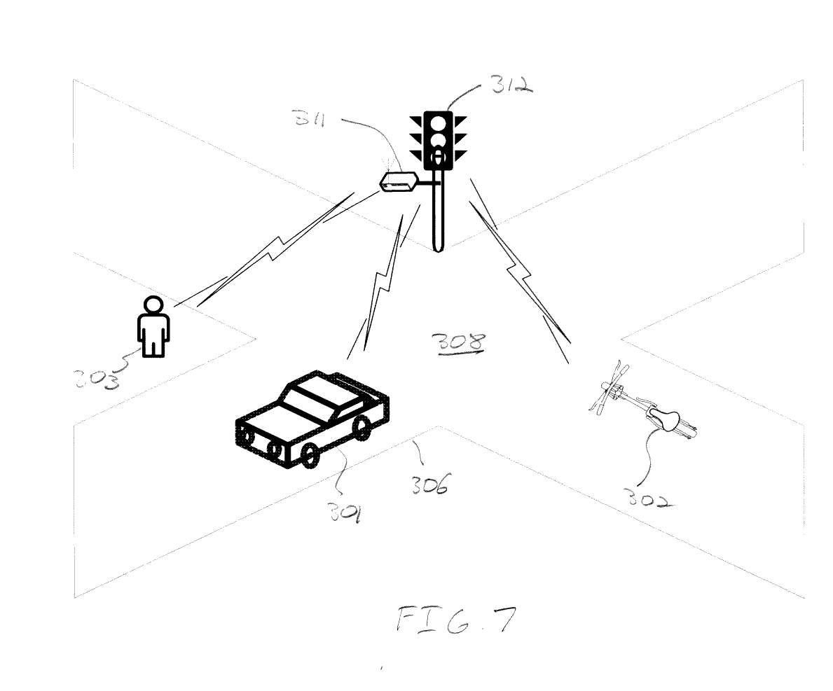

In one method of the invention, for example illustrated in FIG. 6 and FIG.7, the device 26 can be used in a vehicle 301 to detect a nearby cyclist 302, a nearby pedestrian 303 or any other person wearing a predetermined type of low power signal generator or source, for example of the type disclosed herein. As noted herein, suitable low power signal generators or transmitters can include those utilizing ANT, ANT+ or BLE. In one example, as the vehicle 301 is progressing down the road 306, the device 26 carried by the vehicle 301 picks up a low power signal from a suitable transmitting device carried by the pedestrian 303, the cyclist 302 and another person. The driver of vehicle 301 is alerted by the device 26, for example in the manner discussed in FIG. 3 or otherwise herein, to the presence of the person by a sound or message sent by the device 26 to a mobile device such as a cellular phone, for example to a smartphone 202 as discussed herein, or any other suitable means. In one embodiment, the foregoing is accomplished without the device 26 requesting information from any broadcasting node or source.

In one method of the invention, devices are located where vehicles 301 and pedestrians 303 and cyclists 302 are co-located, such as for example at a road intersection 308 (see FIG. 7) or at an entrance or exit of a driveway. In one embodiment, devices 26 can be programmed to have process 46 (see FIG. 3), process 115 (see FIG. 4) or both, and can include some or all of the functionality of device 101. For example, process 115 utilizing radio 32 and antenna 31 of device and can transmit a broadcast message with any suitable information, including any or all of the safety or other payload information discussed above. In one embodiment, such information can include suitable identifying information for each pedestrian and vehicle. Smartphone devices, for example smartphone 206 shown in FIG. 5, can also be programmed to achieve similar functionality, for example the functionality of one or both of devices 26 and 101, through for example a downloadable application. In one embodiment, the downloadable application of the phone communicates with a remote server, which can contain some or all of the processing and other functionality discussed above with respect to the sensing and receiving device and the pulsing and transmitting devices of the invention. A suitable stationary device 311, with added capabilities of the mobile device 26, can be present on a traffic light or bus shelter in the vicinity. CPU 33 of the device can be programmed to run process 46 on device 311, illustrated in FIG. 3, and determine whether pedestrians and/or cyclist are present and cause either an audible or visual alert to be provided, for example by means of feedback mechanism 35 provided in device 311. For example, the device 311 can be integrated with a crosswalk signal 312 to alert the driver of a passing vehicle that there is the potential for a collision with a pedestrian, cyclist or other person detected by the device 311. In one embodiment, the device 311 can transmit a signal to a suitable receiver, such as device 26, carried by the vehicle 301 so as to cause an audible alarm, message or other signal to occur in the vehicle and thus alert the driver of the nearby pedestrian, cyclist or other person. In one embodiment, device 311 utilizes dedicated short range communication (DSRC) to communicate with vehicle 301. DSRC are one-way or two-way short-range to medium-range wireless communication channels specifically designed for automotive use and a corresponding set of protocols and standards.

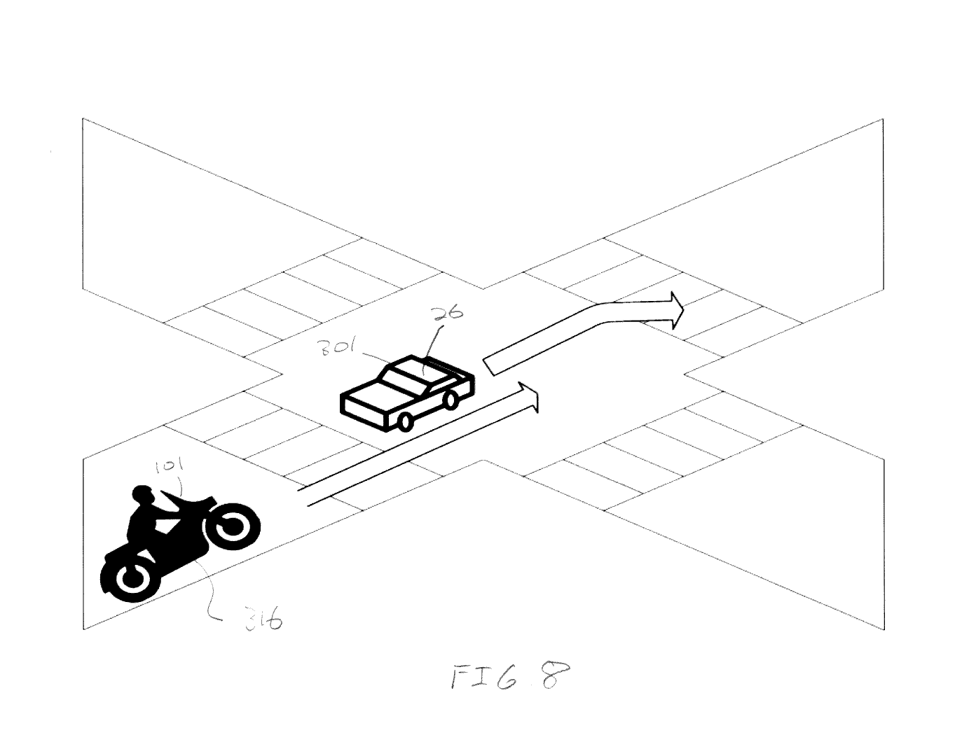

In one method of the invention, for example as illustrated in FIG.8, device 26 is mounted on vehicle 301 can identify a motorcyclist 316 equipped with device 101 travelling in the same direction as the vehicle but at a higher speed in the same or adjacent lanes on a highway or freeway and can avert a collision by informer the vehicle 301 of the motorcyclist 316.

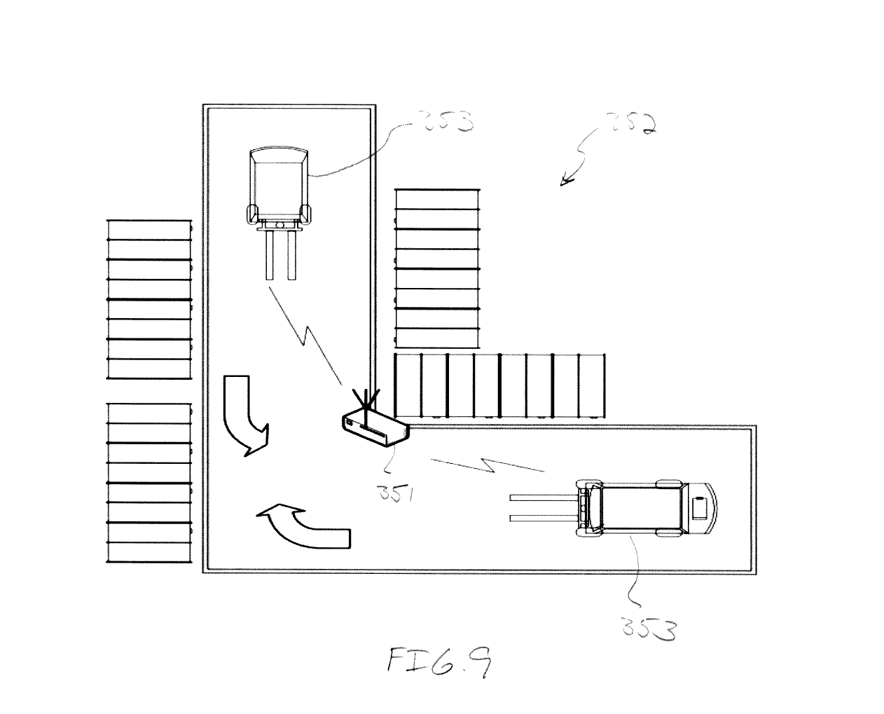

In one method of the invention, for example as illustrated in FIG. 9, a device 351 can be provided that is both a sense or receiving device, such as device 26, and a pulse or transmitting device, such as device 101, and thus be capable of both transmitting suitable lower power signals, for example of the type discussed herein, while also sensing or receiving such signals or other suitable signals. In one embodiment, multiple devices 351 can be utilized to notify each other or other users of their presence while also sensing whether other devices 351 are present. In one method, one or more devices 351 are utilized in a warehouse or factory environment 352 or other situations where vehicles 353, such as forklifts, are operating in close proximity to each other. Estimation of distance between devices 351 can be obtained by any suitable means, for example from the signal strength one device 351 received by another device 351, by the use of location data sensors such as GPS, by the use of other location sensors such as lasers or any combination of the foregoing, carried by the devices 351 or provided nearby.

In one embodiment of the invention as part of a collision avoidance system, transmitters for example of the type disclosed herein can be attached to stationary or other objects that will specifically broadcast to the device 26 such that the device 26 knows that the transmitter is in the area or vicinity of the device 26. For example, the transmitter may broadcast at a frequency or in a manner that only device 26 can detect and/or receive the signal emitted by the transmitter. The transmitter node may have access to GPS or other Global Navigation Satellite Systems (GNSS) such that the GPS coordinates can be sent to the device 26. In this embodiment, the device 26 could calculate its distance from the transmitter based upon its own location coordinates, which can be obtained from a GNSS or other means. In one embodiment, the application is for fixed pulse devices that alert the user device 26 to their location, which can for example be beneficial for road obstructions and other fixed objects upon which a pulse device is mounted or affixed that have the potential for collision with the user of device 26.

Although certain embodiments of the invention have been discussed herein, it is apparent that many more embodiments exist and that the scope of its functionality can be greatly enhanced. While the above description contains many specifics, these should not be construed as limitations on the scope of any embodiment, but as exemplifications of various embodiments thereof.

What is claimed:

1. A collision warning device for use with a plurality of radio frequency signal sources, comprising a receiver for receiving a low power radio frequency signal from a nearby radio frequency signal source, a processor electrically coupled to the receiver and configured to analyze the radio frequency signal for determining whether the signal is from a source capable of colliding with the device, the processor being configured to provide a warning signal when it determines a potential of a collision.

2. The device of claim 1, further comprising a housing for carrying the receiver and the processor.

3. The device of claim 1, further comprising a warning device electrically coupled to the processor for receiving the warning signal and configured to produce a warning selected from the group consisting of a message, an alert, a visual and a sound in response to the warning signal.

4. The device of claim 3, further comprising a housing for carrying the receiver, the processor and the warning device.

5. The device of claim 4, wherein the housing is part of a vehicle.

6. The device of claim 1, wherein the receiver includes an antenna.

7. The device of claim 1, wherein the processor is configured to analyze the low power radio frequency signal according to a signal quality metric.

8. The device of claim 1, wherein the processor is configured to analyze the low power radio frequency signal against predetermined types of radio frequency signals and provide selected radio frequency signals and wherein the processor is configured to analyze only the selected radio frequency signals for determining whether the signal is from a source capable of colliding with the device.

9. The device of claim 8, wherein the processor is configured to analyze low power radio frequency signal against radio frequency signals of the type governed by one of 47 CFR §15.247 and 47 CFR §15.249.

10. The device of claim 8, wherein the processor is configured to analyze the low power radio frequency signal against low power radio frequency signals is in a frequency band selected from the group consisting of 902 to 928 MHz, 2400 to 2483.5 MHz, 5725 to 5850 MHz and any combination thereof.

11. The device of claim 10, wherein the processor is configured to analyze the low power radio frequency signal against low power radio frequency signals having a maximum power not greater than the maximum power permitted under 47 CFR §15.247.

12. The device of claim 10, wherein the processor is configured to analyze the low power radio frequency signal against low power radio frequency signals is in a frequency band and power selected from the group consisting of low power radio frequency signals in the frequency band of 902 to 928 MHz and having a maximum power of 30 dBm, low power radio frequency signals in the frequency band of 2400 to 2483.5 MHz and having a maximum power selected from the group consisting of 20.97 dBm and 30 dBm, low power radio frequency signals in the frequency band of 5725 to 5850 MHz and having a maximum power of 30 dBm and any combination thereof.

13. The device of claim 12, wherein the processor is configured to analyze the low power radio frequency signal against low power radio frequency signals in the frequency bands of 2400 to 2483.5 MHz and having a maximum power of 10 dBm.

14. The device of claim 8, wherein the processor is configured to analyze only predetermined types of radio frequency signals selected from the group consisting of Bluetooth low energy (BLE) signals, ANT signals, ANT+ signals and any combination of the foregoing for determining whether the signal is from a source capable of colliding with the device.

15. The device of claim 1, further comprising an antenna electrically coupled to the processor for transmitting the warning signal to a remote electrical device.

16. The device of claim 1, further comprising a memory device for storing signal information for the plurality of radio frequency signal sources, wherein the processor is electrically coupled to the memory device and is configured to access information stored in the memory device relative to the source in determining whether the signal is from a source capable of colliding with the device.

17. The device of claim 1, further comprising a memory device electrically coupled to the processor, wherein the processor is configured to analyze the radio frequency signal according to a signal quality metric and store signal metrics relative to the source in the memory device.

18. The device of claim 1, further comprising a global positioning navigation receiver for obtaining location data coupled to the processor.

19. The device of claim 18, wherein the processor is configured to compare location data obtained by the global positioning navigation receiver with location data obtained from the radio frequency signal source for determining whether the radio frequency signal source is capable of colliding with the device.

20. A system, comprising the device of claim 1 in combination with a radio frequency signal source.

21. The system of claim 20, wherein the radio frequency signal source is selected from the group consisting of a bike sensor, a watch, a smartphone, a mobile device, a heart rate monitor, a bicycle cadence meter, a bicycle power meter, a bicycle speed sensor, a wearable device and a personal device.

22. The system of claim 20, wherein the signal source includes a transmitter for transmitting the radio frequency signal.

23. The system of claim 1, wherein the processor is configured to analyze the radio frequency signal for determining the potential of a collision based upon the reception strength of the signal.

24. A collision warning device, comprising a support body, a transmitter of low power radio frequency signals carried by the support body, a positioning device for determining the position of the support body carried by the support body, a processor carried by the body and coupled to the positioning device and the transmitter, the processor being configured to receive positioning information from the positioning device and to instruct the transmitter to transmit the position information over a low power radio frequency signal.

25. The device of claim 24, wherein the positioning device is a GPS device.

26. The device of claim 24, wherein the support body is a hand-holdable housing.
